(19) United States
(12) Patent Application Publication
(10) Pub. No.: US 2015/0379448 A1
(43) Pub. Date: Dec. 31, 2015

(54) GRAPHICAL REPRESENTATIONS OF A PORTFOLIO OF PROJECTS

(71) Applicant: Hewlett-Packard Development Company, L.P., Houston, TX (US)

(72) Inventors: Cipriano A. Santos, Modesto, CA (US); Fernando Orozco Sanchez, Tlaquepaque (MX); Ivan Lopez-Sanchez, Hermosillo (MX); David Farrington Ludwig, Austin, TX (US); Ericka Margaret Norman, Austin, TX (US)

(21) Appl. No.: 14/320,185

(22) Filed: Jun. 30, 2014

(51) Int. Cl. G06Q 10/06; G06F 3/0484; H04L 29/06; G06F 3/0482

(52) U.S. Cl. CPC G06Q 10/06313; G06F 3/0482; G06F 3/04842; H04L 65/403; H04L 63/102

(57) ABSTRACT

Examples relate to optimizing a portfolio of projects. The examples disclosed herein enable triggering a display of a first graphical representation that may illustrate costs for executing a first portfolio of projects over a time period. The first portfolio may include a set of projects that is selected and scheduled based on a mathematical optimization model. The examples further enable triggering a display of a second graphical representation that may illustrate how the set of projects is scheduled over the time period. The first graphical representation and the second graphical representation may be aligned to a common timeline.

### BACKGROUND

Large enterprises, such as corporations and governments, commonly have to manage internal and external projects, like information technology (IT) and other types of projects, on the order of millions or even billions of dollars in cost on an annual basis. Due to scarce resources, including personnel, time, and money, such enterprises have to carefully select which proposed projects they will actually pursue within a given calendar year or other period of time. A group of projects that are selected and scheduled in this manner is referred to and known as a portfolio of projects.

### BRIEF DESCRIPTION OF THE DRAWINGS

The following detailed description references the drawings, wherein:

FIG. 1 is a block diagram depicting an example environment in which various examples may be implemented as a portfolio optimization system.

FIG. 2 is a block diagram depicting an example machine-readable storage medium comprising instructions executable by a processor for creating a scenario an optimized portfolio of projects based on the scenario, generating graphical representations of the portfolio, and causing a display of the graphical representations.

FIG. 3 is a flow diagram depicting an example method for triggering a display of graphical representations of an optimized portfolio of projects.

FIG. 4 is a flow diagram depicting an example method for causing a display of graphical representations of portfolios of projects for a side-by-side comparison.

FIG. 5 is a flow diagram depicting an example method for sharing scenarios and optimized portfolios generated based on the scenarios among different users.

FIG. 6 is a diagram depicting an example user interface for displaying a plurality of graphical representations of an optimized portfolio on a common timeline.

FIG. 7 is a diagram depicting an example user interface for displaying graphical representations of optimized portfolios for a side-by-side comparison.

FIG. 8 is a diagram depicting an example user interface for comparing a plurality of optimized portfolios based on differences in project selection.

FIG. 9 is a diagram depicting an example user interface for comparing a plurality of optimized portfolios based on differences in project schedule.

FIG. 10 is a diagram depicting an example user interface for managing scenarios for optimizing portfolios of projects.

FIG. 11 is a diagram depicting an example user interface for managing shared scenarios for optimizing portfolios of projects.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only and are not intended as a definition of the limits of the invention. While several examples are described in this document, modifications, adaptations, and other implementations are possible. Accordingly, the following detailed description does not limit the disclosed examples. Instead, the proper scope of the disclosed examples may be defined by the appended claims.

Large enterprises manage a large number of projects annually. Due to scarce resources and other constraints, such enterprises must carefully select which projects to include in a given portfolio that they will actually pursue and schedule them appropriately. Further, multiple objectives within an enterprise that are to be satisfied by completion of the projects can make this selection and scheduling process extremely difficult, particularly where these objectives are competing or in conflict with one another. Manually intensive approaches have typically been employed to select a desired portfolio of projects, but such approaches are cumbersome and typically do not properly optimize the objectives.

Examples disclosed herein address these issues by providing a portfolio optimization tool that optimizes the selection and scheduling of a portfolio of projects such that the trade-offs among various conflicting objectives are optimized, while satisfying multiple constraints. Using this tool, a user may create multiple what-if scenarios to simulate various different combinations of objectives, constraints, and other configurations in optimizing a portfolio of projects. The user may review and compare optimized portfolios generated based on those scenarios and make a decision as to which optimized portfolio to use for the actual implementation.

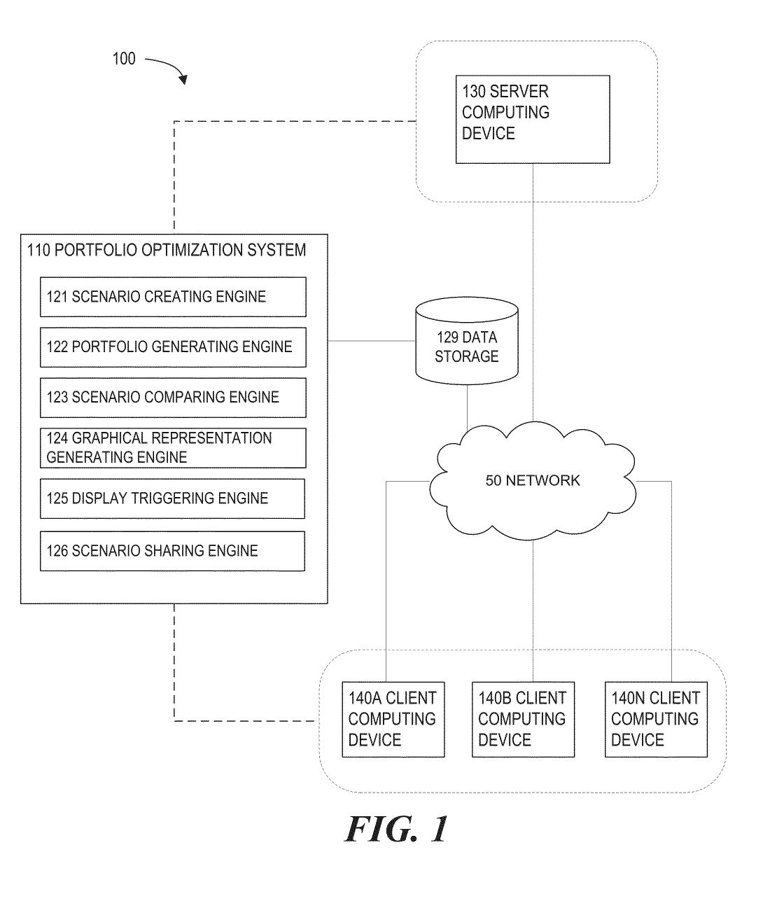

FIG. 1 is an example environment 100 in which various examples may be implemented as a portfolio optimization system 110. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may include any type of computing device providing a user interface through which a user can interact with a software application. For example, client computing devices 140 may include a laptop computing device, a desktop computing device, an all-in-one computing device, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving one or more software applications for consumption by client computing devices 140.

The various components (e.g., components 129, 130, and 140) depicted in FIG. 1 may be coupled to at least one other component via a network 50. Network 50 may comprise any infrastructure or combination of infrastructures that enable electronic communication between the components. For example, network 50 may include any one or more of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, portfolio optimization system 110 and the various components described herein may be implemented in hardware and/or programming that configure hardware. Furthermore, in FIG. 1 and other Figures described herein, different numbers of components or entities than depicted may be used.

Portfolio optimization system 110 may create a what-if scenario for optimizing a portfolio of projects. A scenario may be developed by specifying various configurations including at least one objective to be optimized, at least one constraint, at least one configuration parameter, and/or other configurations. The various configurations may be specified and/or defined by system 110 and/or based on user input. Multiple scenarios may be created to simulate various situations with different objectives, constraints, configuration parameters, and/or other configurations. In this manner, a user may try out several different scenarios, review and compare optimized portfolios generated based on those scenarios, and make an informed determination as to which optimized portfolio to use for the actual implementation. Portfolio optimization system 110 may generate an optimized portfolio of projects that are selected and/or scheduled based on a particular scenario. Portfolio optimization system 110 may compare optimized portfolios generated based on different scenarios. In some instances, the optimized portfolios may be compared to a baseline portfolio that includes only the projects that have been currently committed.

Portfolio optimization system 110 may generate graphical representations of the baseline portfolio and/or optimized portfolios generated based on the scenarios. Further, graphical representations of the comparison results may be generated. Portfolio optimization system 110 may further trigger or cause a display of the graphical representations. In some instances, portfolio optimization system 110 may present an output interface for displaying at least two graphical representations on a common timeline. For example, a budget-cost-gap chart and a Gantt chart may be displayed in such a way that the two graphical representations are aligned to a common timeline. By enabling a display of such graphical representations on a common timeline, users may be able to visualize a relationship between the project schedule and the costs (or resources are consumed). Moreover, portfolio optimization system 110 may enable users to share scenarios and/or optimized portfolios that have been generated based on the scenario with other users.

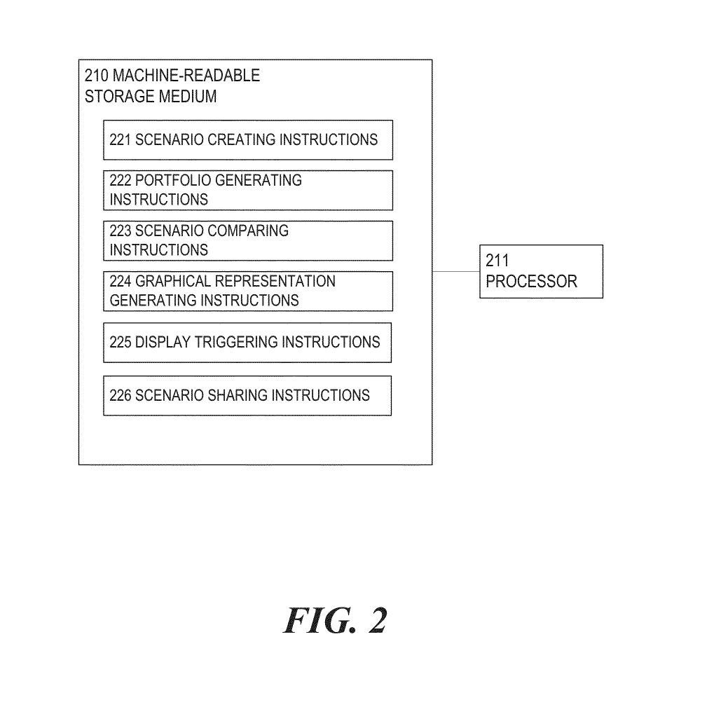

To facilitate these and other functions, portfolio optimization system 110 may comprise a scenario creating engine 121, a portfolio generating engine 122, a scenario comparing engine 123, a graphical representation generating engine 124, a display triggering engine 125, a scenario sharing engine 126, and/or other engines. The term “engine”, as used herein, refers to a combination of hardware and programming that performs a designated function. As is illustrated respect to FIG. 2, the hardware of each engine, for example, may include one or both of a processor and a machine-readable storage medium, while the programming is a set of instructions or code stored on the machine-readable storage medium and executable by the processor to perform the designated function.

Scenario creating engine 121 may create a what-if scenario for optimizing a portfolio of projects. A scenario may be developed by specifying various configurations including at least one objective to be optimized, at least one constraint, at least one configuration parameter, and/or other configurations. The various configurations may be specified and/or defined by system 110 and/or based on user input. For example, a user may create a scenario and specify at least one of the various configurations in the scenario. The objectives, constraints, configuration parameters, and/or other configurations defined in the scenario may be used to generate an optimized portfolio of projects where the projects in the resulting portfolio are selected and scheduled based on this scenario. For example, an optimization mathematical model may determine an optimal selection and scheduling of projects that have been proposed for inclusion in the portfolio while considering the objectives, constraints, configuration parameters, and/or other configurations defined in the scenario. Multiple scenarios may be created to simulate various situations with different objectives, constraints, configuration parameters, and/or other configurations. In this manner, a user may try out several different scenarios, review and compare optimized portfolios generated based on those scenarios, and make an informed determination as to which optimized portfolio to use for the actual implementation.

Examples of the objectives may include a project ranking and project benefit (e.g., total direct benefit, total indirect benefit, etc.). For example, an executive council may rank each proposed project that is under consideration for inclusion within the portfolio that the organization actually pursues. In this case, the proposed projects may be ranked from most desired to least desired or assigned importance values (e.g., selected from a one to ten range). In another example, the benefit of each proposed project, irrespective of implementation costs, may be provided in monetary terms and normalized for a common time period, such as annually. Other examples of the objectives may include employee satisfaction, financial benefit, operational expense, risk level, scope of benefits, and/or other objectives.

Examples of the constraints may include resource constraints such as monetary (e.g., budget or cost) constraints and personnel (e.g., headcount) constraints. Such constraints may ensure that the total consumption of resources such as money or personnel does not exceed the available capacity. In one example, the monetary constraints may be differentiated by various types of business units, divisions, initiatives, labor types (e.g., IT labor, business labor, non-labor, etc.), and/or other types. In another example, the personnel constraints may be differentiated by various types of skills and roles. Moreover, the constraints may include timing constraints, such as a project length or duration, a start or end time of the project, and time-dependencies among projects.

Any changes to the available resources and/or timing may be used to dynamically update the values for the constraints. The values for the constraints may be updated in real-time in response to the changes to the resources and/or timing or at a predetermined time interval (e.g., hourly, daily, weekly, monthly, quarterly, yearly, etc.). For example, if the budget for the month of July has been reduced by an executive council, that reduction in the budget may be reflected in the value for the budget constraint for July. In another example, Human Resources (HR) personnel may anticipate a reduction in workforce in a particular department for the month of January and decrease the available headcount for that month, which may in turn change the value associated with the personnel constraint for January. In yet another example, after learning that the release date for a product has been changed to an earlier date, a project manager may update the end time of the project that is developing the product, allowing the associated value for the timing constraint to be updated. The constraints may include other types of constraints as well, in addition to and/or in lieu of resource and/or timing constraints.

Configuration parameters may include a plurality of variables that may be set and/or updated based on user input. Through the configuration parameters, users may enjoy the opportunity to shape the portfolio based on their individual needs, desires, and goals.

Examples of the configuration parameters may include an optimization mathematical model (e.g., Basic Optimization Mechanism (BOM), Multi-Criteria Ranking Mechanism (MCRM), Pareto Optimization Mechanism (POM), etc.) to be used for the optimization, an optimization time window (e.g., a time window for which projects included in the resulting optimized portfolio should be scheduled), a selection of a particular project to be included in or excluded from the portfolio, a required number of selected projects for inclusion in the portfolio, any changes to the constraints (e.g., increasing/decreasing available budget, headcount, modifying the project timeline, duration, etc.), and/or other parameters. For example, the user may configure the available budget by increasing/decreasing the budget by quarter or even throughout the entire planning horizon. In another example, the user may modify the start date for a project and define whether the start date should be fixed or flexible.

The configuration parameters may also include logical constraints on a pair of projects (e.g., Project 1 and Project 2). Logical constraints can be used to model various logical requirements among projects. For example, the logical constraint “PREDECESSOR-SUCESSOR” may mean that Project 2 cannot be selected unless Project 1 has been selected (e.g., prerequisite relationship). It can even impose a rule that ensures that Project 2 is started after a designated number of months (e.g., two months) or after a certain percentage of completion (e.g., 80% completion) of Project 1. In another example, the logical constraint “OR” may indicate that Project 1 and Project 2 cannot be simultaneously selected (e.g., exclusive relationship). In other words, the optimization mathematical model may either select Project 1 or Project 2, but not both at the same time. In yet another example, the logical constraint “IF AND ONLY IF” may use a both-or-nothing and all-or-nothing approach. For instance, a user may want to select both projects 1 and 2 or none of the two. This type of constraint is useful when Project 1 and 2 are related projects.

The configuration parameters may further include a portfolio distribution range. This enables a user to set upper and lower bounds on the percentage of number, cost, and/or personnel of projects by project category. This means that a user may require a certain percentage of the number of projects that make up a portfolio to come from a particular project category (e.g., investment category). For example, the user may configure the scenario to require 20%-25% of the number of projects to come from the IT project category whereas 30% of the number of projects to come from the investment category. In another example, the user might require 50% of the total cost to come from projects in the IT project category.

The configuration parameters may further include an optimization smoothness. For example, the user may input a desired level of optimization smoothness such that personnel resources can be handled more realistically. By configuring the optimization smoothness, the system may acknowledge that real-time ramp-up or layoff of human resources is not feasible or realistic.

The configuration parameters may further include a scenario scope. For example, each project may belong to a particular “investment area” that may represent business areas of interest for the enterprise. The scenario scope may include a subset of the investment areas under consideration by the enterprise for the purpose of optimizing. Note that when all investment areas are selected, the scenario has a global scope, and all of the available projects may be considered for the optimization.

Scenario creating engine 121 may create a scenario by creating a new scenario or copying an existing scenario. When creating a new scenario, a user may, via a user interface, provide a name for the scenario, and configure the scenario by specifying at least one objective to be optimized, an optimization mathematical model to be used for the optimization, scenario scope, optimization time window, optimization business metric (e.g. cost) smoothness, and/or by specifying or modifying other configuration parameters. For example, when the user selects a multi-objective optimization mathematical model, the user may be prompted to identify a list of objectives to be used for the optimization. In some instances, the user may be asked to rank the objectives in order of importance where the importance level assigned to each objective will be taken into account during the optimization.

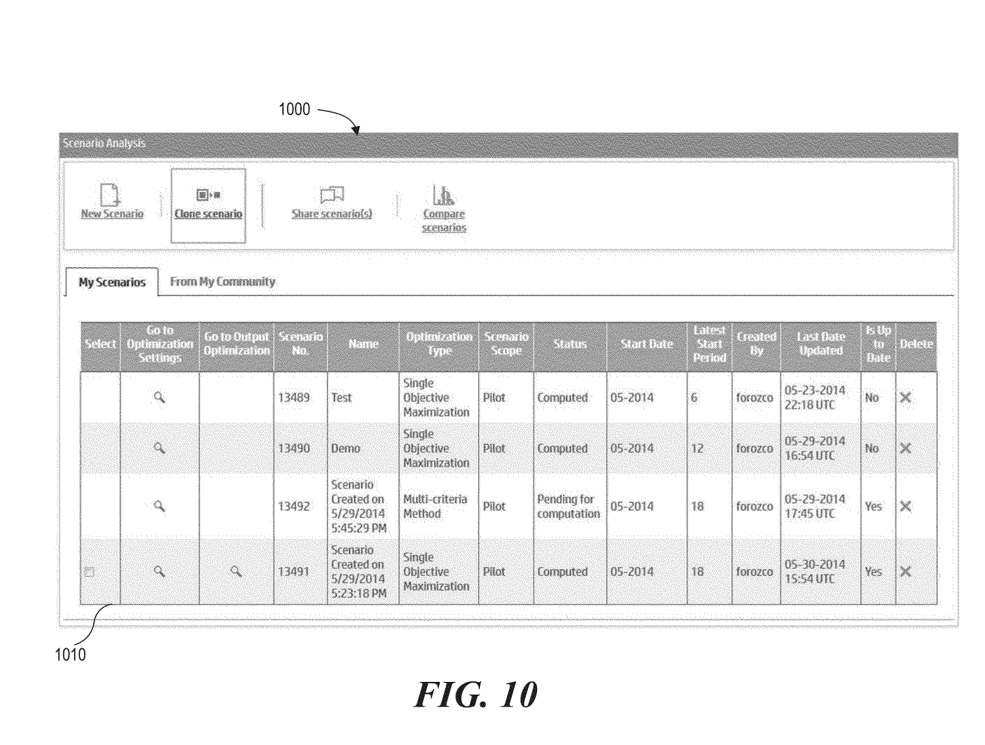

In some instances, instead of creating a new scenario from scratch, scenario creating engine 121 may copy or clone an existing scenario and use the copy to create a scenario. Existing scenarios may include a scenario that has been previously created but not yet optimized and/or a scenario that has been previously created and optimized with a corresponding optimized portfolio. For example, a user created a first scenario but did not get to complete the configuration or run the optimization. On the other hand, a second scenario was created and optimized to produce an optimized portfolio of projects. Both the first scenario and the second scenario may be stored (e.g., in a data storage 129) for future use. The user, when creating a third scenario, may copy or clone either the first scenario or the second scenario to start the process. The copy of the scenario may be re-configured to modify or update the original configurations and/or used to generate a new optimized portfolio of projects. Moreover, the user may be able to select which existing scenario to copy from a list of scenarios that the user has previously created or that the user otherwise has access to (e.g., scenarios shared by other users). An example user interface showing multiple scenarios created and stored for future use is illustrated in FIG. 10.

Portfolio generating engine 122 may generate an optimized portfolio of projects that are selected and/or scheduled based on a scenario. For example, portfolio generating engine 122 may use a mathematical optimization model to optimize the at least one objective defined in the scenario in consideration of the at least one constraint and other configurations defined in the scenario. Further, portfolio generating engine 122 may generate a baseline portfolio that includes only the projects that have been currently committed. The baseline portfolio, therefore, may show the current state of the portfolio. The currently committed projects may be included in the optimized portfolios by default.

Scenario comparing engine 123 may compare the optimized portfolios generated based on different scenarios. Further, the optimized portfolios may be compared to the baseline portfolio. The portfolios (e.g., optimized and/or baseline portfolios) may be compared based on various metrics including the total cost for each portfolio, the total direct/indirect benefit for each portfolio, a portfolio ranking value assigned to each portfolio, etc. In some instances, at least two portfolios may be compared based on the difference in their project selections. In this example, scenario comparing engine 123 may generate a first list of projects that are included in the first portfolio but not in the second portfolio. A second list of projects may be also generated where the second list shows projects that are included in the second portfolio but not in the first portfolio. In another example, scenario comparing engine 123 may compare at least two portfolios based on the difference in their project schedules. In doing so, scenario comparing engine 123 may identify a common project included in both the first portfolio and the second portfolio, which may have different schedules for the two portfolios. In this way, the user may be informed that although the same project has been selected for both portfolios, their schedules for that project are different from one another.

Graphical representation generating engine 124 may generate graphical representations of a baseline portfolio and/or an optimized portfolio generated based on a scenario. Graphical representation generating engine 124 may generate a first graphical representation that may illustrate a distribution of costs involved in executing projects in a particular project portfolio. Further, the first graphical representation may depict how resources are consumed by the projects selected in a particular project portfolio. The first graphical representation may, in some instances, illustrate the budget and costs in the same representation such that a gap analysis of the budget and costs can be shown. The first graphical representation, for example, may be a time-based chart that illustrates the costs, the budget, or the budget-cost gap analysis on a timeline. Graphical representation generating engine 124 may generate a second graphical representation that may illustrate how the projects of a particular portfolio are scheduled. For example, the second graphical representation may comprise a Gantt chart that illustrates when each project of the portfolio begins or ends on a timeline.

Graphical representation generating engine 124 may generate graphical representations of the comparison results made by scenario comparing engine 123. The graphical representations may include a table that shows comparison of at least two portfolios (e.g., optimized and/or baseline portfolios) based on various metrics. For example, the first column of the table may list different metrics including the total cost, the total direct/indirect benefit, a portfolio ranking value, etc. In the second column of the table, a first optimized portfolio may be shown with a value corresponding to each metric. The third column may include the values corresponding to the metrics for a second optimized portfolio. Similarly, more columns may be added to the table to include additional optimized portfolios or a baseline portfolio.

In another example, when two portfolios are compared based on the difference in their project selections, graphical representation generating engine 124 may generate a table showing a first list of projects that are included in the first portfolio but not in the second portfolio. Similarly, another table may be generated to show a second list of projects that are included in the second portfolio but not in the first portfolio. In yet another example, graphical representation generating engine 124 may generate a Gantt chart that illustrates the difference in their project schedules. In this example, the Gantt chart may show at least one common project that has been selected for both portfolios. For that common project, the Gantt chart may show when that project begins and ends for the first portfolio and when that same project begins and ends for the second portfolio.

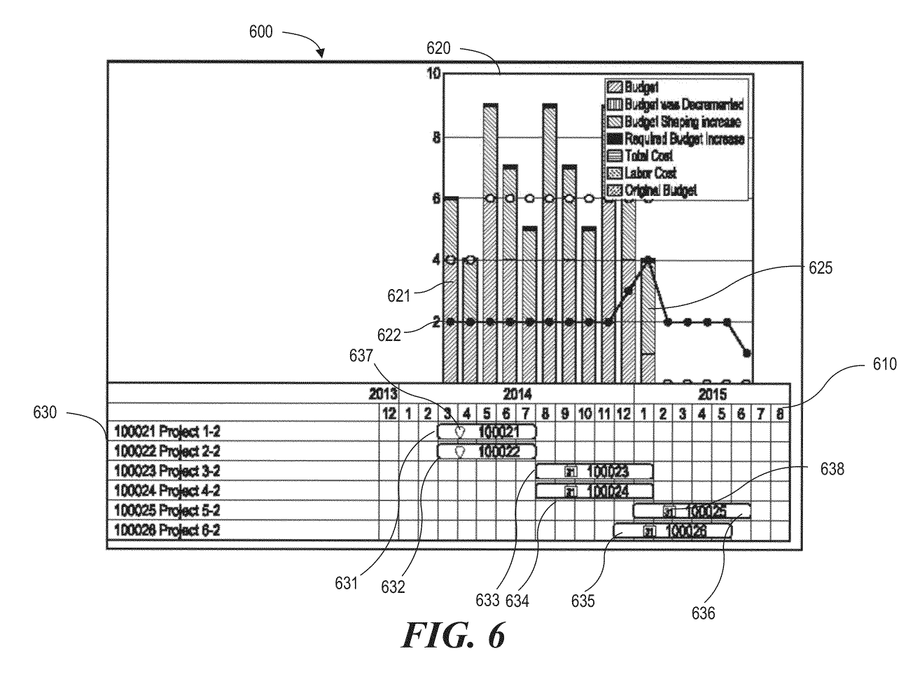

Display triggering engine 125 may trigger or cause a display of the graphical representations generated by graphical representation generating engine 124. The display may be presented via a user interface on a client computing device (e.g., client computing device 140A, 140B, . . . , or 140N). In some instances, server computing device 130 may provide a graphical representation for display via a web interface such that a user on a client computing device may enter a designated web address to view the graphical representation via the web interface. In other instances, the display may be presented via a user interface provided by a software application installed on a client computing device. Example user interfaces showing the above-described graphical representations are illustrated in FIGS. 6-9.

Display triggering engine 125 may present an output interface for displaying at least two graphical representations on a common timeline. The timeline may comprise a graphical illustration of a time axis, and time values arranged along the time axis. The time values may illustrate a timescale defined in a particular unit of time (e.g., hours, days, weeks, months, quarters, years, etc.). Further, in some instances, the time axis may not be explicitly shown on the display, but instead may be implied by an arrangement and ordering of information on the display.

In some instances, the first graphical representation may be represented as a bar or line chart. Assuming that the first graphical representation illustrates the costs for executing a first portfolio of projects over a time period, each bar or vertex of the first graphical representation may indicate the costs associated with one or more projects that are scheduled to occur during a particular portion of the timeline. For example, where the timeline is defined in months, each bar or vertex of the first graphical representation may indicate the costs associated with one or more projects that are scheduled to occur during a particular month of the timeline. On the other hand, the second graphical representation, which may comprise a Gantt chart, may illustrate the start and end (or completion) dates of various projects in the first portfolio. Each bar of the Gantt chart may be associated with a particular project and shows the start and end dates of that project on the timeline. Thus, each bar or vertex of the first graphical representation may be aligned with a portion of the bar of the second graphical representation that falls within the same portion of timeline.

By way of example and for purposes of illustration, the first portfolio includes six projects (e.g., Projects 100021, 100022, 100023, 100024, 100025, and 100026). Project 100021 has been scheduled to start in March 2014 and end in July 2014. Project 100022 has the same schedule as Project 100021. Project 100023 and Project 100024 start in August 2014 and end in January 2015. Project 100025 starts in January 2015 and ends in June 2015. Project 100026 starts in December 2014 and ends in May 2015. In this example, each bar or vertex of the first graphical representation for the first five months (e.g., March 2014-July 2014) may represent the costs incurred by Projects 100021 and 100022 for each particular month. Similarly, the bar of vertex of the first graphical representation for the month of January 2015 may, for example, indicate the costs incurred by the four projects (e.g., Projects 100023-26) that fall within the same month. Note that the first graphical representation may also illustrate how resources (e.g., budget) are consumed by the projects in the portfolio over time. In some instances, the first graphical representation may illustrate budget-cost gap analysis. By enabling a display of such graphical representations on a common timeline, as discussed above, users may be able to visualize a relationship between the project schedule and the costs (or how resources are consumed).

Display triggering engine 125 may present an output interface for displaying at least two graphical representations for a side-by-side comparison. For example, Optimized Portfolio 1 generated based on Scenario A, Optimized Portfolio 2 generated based on Scenario B, and/or a baseline portfolio may be compared by showing the budget-cost-gap analysis charts side by side on a display.

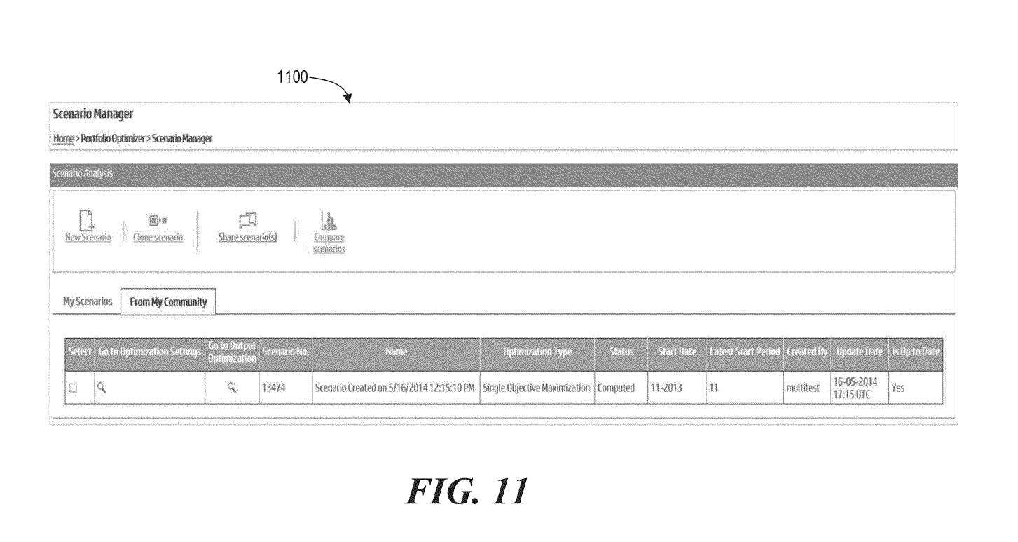

Scenario sharing engine 126 may share, among various users, scenarios and/or optimized portfolios. Scenario sharing engine 126 may receive, from a first user, a request to share a first scenario with a second user. In response to the request, the second user may be authorized to access the first scenario and/or a corresponding optimized portfolio (if the optimization has been already performed on the first scenario). The second user may also gain access to some or all of the graphical representations generated by graphical representation generating engine 124. Display triggering engine 125 may present an output interface for displaying the graphical representations that the second user may be interested in viewing. The second user may be allowed to modify objectives, constraints, and/or other configuration parameters in the first scenario to create a new scenario. In some instances, the second user may comprise a group of users. The group of users may be defined by a geography, role, team, business unit, etc. For example, the first user may share the first scenario with his team members by identifying his team via scenario sharing engine 126. In another example, the first scenario may be shared with all of the employees located in Asia. An example user interface showing a scenario being shared by another user is illustrated in FIG. 11.

In performing their respective functions, engines 121-126 may access data storage 129. Data storage 129 may represent any memory accessible to portfolio optimization system 110 that can be used to store and retrieve data. Data storage 129 may comprise floppy disks, hard disks, optical disks, tapes, solid state drives, random access memory (RAM), read-only memory (ROM), electrically-erasable programmable read-only memory (EEPROM), flash drives, portable compact disks, and/or other storage media for storing computer-executable instructions and/or data. Portfolio optimization system 110 may access data storage 129 locally or remotely via network 50 or other networks.

Data storage 129 may include a database to organize and store data. Database may be, include, or interface to, for example, an Oracle™ relational database sold commercially by Oracle Corporation. Other databases, such as Informix™, DB2 (Database 2) or other data storage, including file-based (e.g., comma or tab separated files), or query formats, platforms, or resources such as OLAP (On Line Analytical Processing), SQL (Structured Query Language), a SAN (storage area network), Microsoft Access™, MySQL, PostgreSQL, HSpace, Apache Cassandra, MongoDB, Apache CouchDB™, or others may also be used, incorporated, or accessed. The database may reside in a single or multiple physical device(s) and in a single or multiple physical location(s). The database may store a plurality of types of data and/or files and associated data or file description, administrative information, or any other data.

FIG. 2 is a block diagram depicting an example machine-readable storage medium 210 comprising instructions executable by a processor for creating a scenario an optimized portfolio of projects based on the scenario, generating graphical representations of the portfolio, and causing a display of the graphical representations.

In the foregoing discussion, engines 121-126 were described as combinations of hardware and programming. Engines 121-126 may be implemented in a number of fashions. Referring to FIG. 2, the programming may be processor executable instructions 221-226 stored on a machine-readable storage medium 210 and the hardware may include a processor 211 for executing those instructions. Thus, machine-readable storage medium 210 can be said to store program instructions or code that when executed by processor 211 implements portfolio optimization system 110 of FIG. 1.

Machine-readable storage medium 210 may be any electronic, magnetic, optical, or other physical storage device that contains or stores executable instructions. In some implementations, machine-readable storage medium 210 may be a non-transitory storage medium, where the term “non-transitory” does not encompass transitory propagating signals. Machine-readable storage medium 210 may be implemented in a single device or distributed across devices. Likewise, processor 211 may represent any number of processors capable of executing instructions stored by machine-readable storage medium 210. Processor 211 may be integrated in a single device or distributed across devices. Further, machine-readable storage medium 210 may be fully or partially integrated in the same device as processor 211, or it may be separate but accessible to that device and processor 211.

In one example, the program instructions may be part of an installation package that when installed can be executed by processor 211 to implement portfolio optimization system 110. In this case, machine-readable storage medium 210 may be a portable medium such as a floppy disk, CD, DVD, or flash drive or a memory maintained by a server from which the installation package can be downloaded and installed. In another example, the program instructions may be part of an application or applications already installed. Here, machine-readable storage medium 210 may include a hard disk, optical disk, tapes, solid state drives, RAM, ROM, EEPROM, or the like.

Processor 211 may be one or more central processing units (CPUs), microprocessors, and/or other hardware devices suitable for retrieval and execution of instructions stored in machine-readable storage medium 210. Processor 211 may fetch, decode, and execute program instructions 221-226, and/or other instructions. As an alternative or in addition to retrieving and executing instructions, processor 211 may include one or more electronic circuits comprising a number of electronic components for performing the functionality of one or more of instructions 221-226, and/or other instructions.

In FIG. 2, the executable program instructions in machine-readable storage medium 210 are depicted as scenario creating instructions 221, portfolio generating instructions 222, scenario comparing instructions 223, graphical representation generating instructions 224, display triggering instructions 225, display triggering instructions 225, and scenario sharing instructions 226. Instructions 221-226 represent program instructions that, when executed, cause processor 211 to implement engines 121-126, respectively.

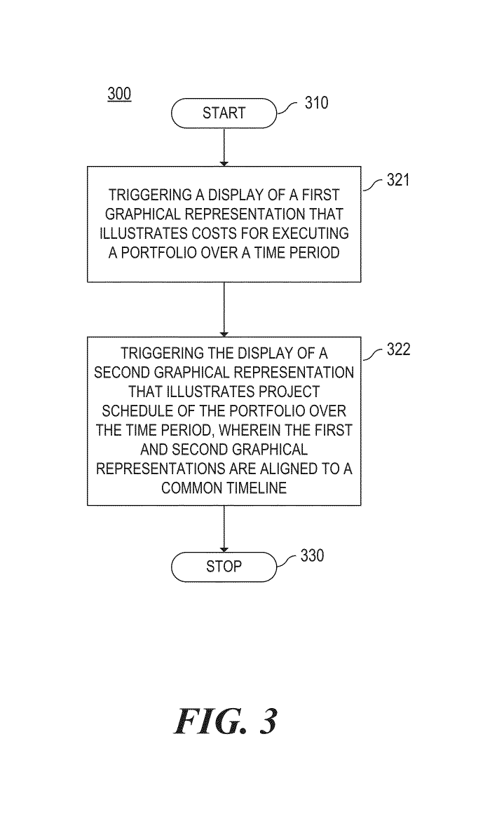

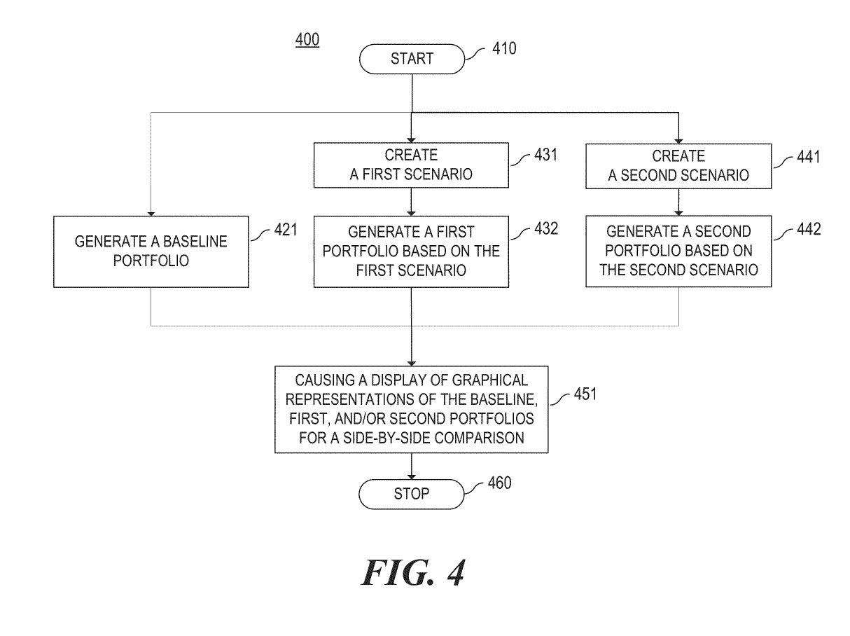

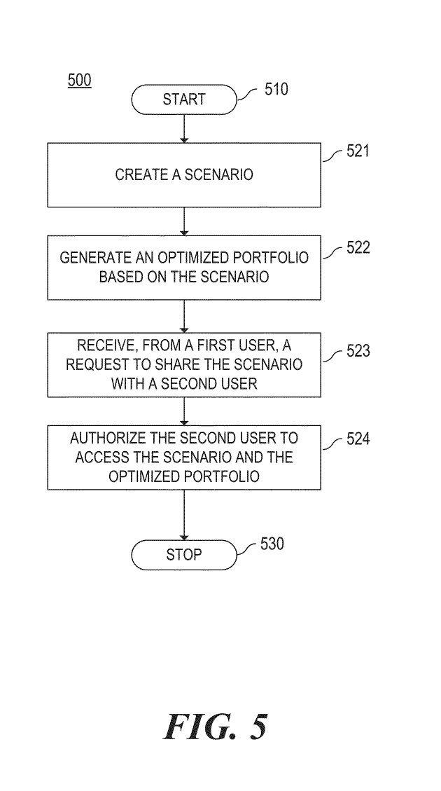

FIG. 3 is a flow diagram depicting an example method 300 for triggering a display of graphical representations of an optimized portfolio of projects. The various processing blocks and/or data flows depicted in FIG. 3 (and in the other drawing figures such as FIGS. 4 and 5) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 300 as illustrated (and described in greater detail below) is meant be an example and, as such, should not be viewed as limiting. Method 300 may be implemented in the form of executable instructions stored on a machine-readable storage medium, such as storage medium 210, and/or in the form of electronic circuitry.

Method 300 may start in block 310 and proceed to block 321 where a display of a first graphical representation may be triggered. The first graphical representation may illustrate costs for executing a portfolio of projects over a time period. The first graphical representation, for example, may be a time-based chart that shows the costs on a timeline. The timeline may comprise a graphical illustration of a time axis, and time values arranged along the time axis. The time values may illustrate a timescale defined in a unit of time (e.g., hours, days, weeks, months, quarters, years, decades, etc.).

In block 322, the display of a second graphical representation may be triggered where the second graphical representation may illustrate how the projects of the portfolio are scheduled over the same time period. The first graphical representation and the second graphical representation, therefore, may be aligned to the common timeline. The second graphical representation, in some instances, may comprise a Gantt chart that illustrates when each project of the portfolio begins or ends on the timeline. In some instances, the first graphical representation may be represented as a bar or line chart. Assuming that the first graphical representation illustrates costs for executing a first portfolio of projects over a time period, each bar or vertex of the first graphical representation may indicate the costs associated with one or more projects that are scheduled to occur during a portion of the timeline. For example, where the timeline is defined in months, each bar or vertex of the first graphical representation may indicate the costs associated with one or more projects that are scheduled to occur during a particular month of the timeline. On the other hand, the second graphical representation, which may comprise a Gantt chart, may illustrate the start and end (or completion) dates of various projects in the first portfolio. Each bar of the Gantt chart may be associated with a particular project and shows the start and end dates of that project on the timeline. Thus, each bar or vertex of the first graphical representation may be aligned with a particular portion of the bar of the second graphical representation that falls within the same portion of timeline. Method 300 may then stop in block 330.

Referring back to FIG. 1, display triggering engine 125 may be responsible for implementing method 300.

FIG. 4 is a flow diagram depicting an example method 400 for causing a display of graphical representations of portfolios of projects for a side-by-side comparison. Method 400 may be implemented in the form of executable instructions stored on a machine-readable storage medium, such as storage medium 210, and/or in the form of electronic circuitry.

Method 400 may start in block 410 and proceed to block 421 where a baseline portfolio is generated. The baseline portfolio includes currently committed projects.

Method 400 may include creating various scenarios such as a first scenario (block 431) and a second scenario (block 441). Other scenarios may be created. A scenario may specify at least one objective to be optimized, at least one constraint, and/or at least one configuration parameter. Multiple scenarios may be created to simulate various situations with different objectives, constraints, configuration parameters, and/or other configurations. The objectives, constraints, configuration parameters, and/or other configurations defined in the scenario may be used to generate an optimized portfolio of projects where the projects in the resulting portfolio are selected and scheduled based on this scenario. For example, a mathematical optimization model may determine an optimal selection and scheduling of projects that have been proposed for inclusion in the portfolio while considering the objectives, constraints, configuration parameters, and/or other configurations defined in the scenario. In this way, in block 432, a first portfolio of projects may be generated based on the first scenario, and in block 442, a second portfolio of projects may be generated based on the second scenario.

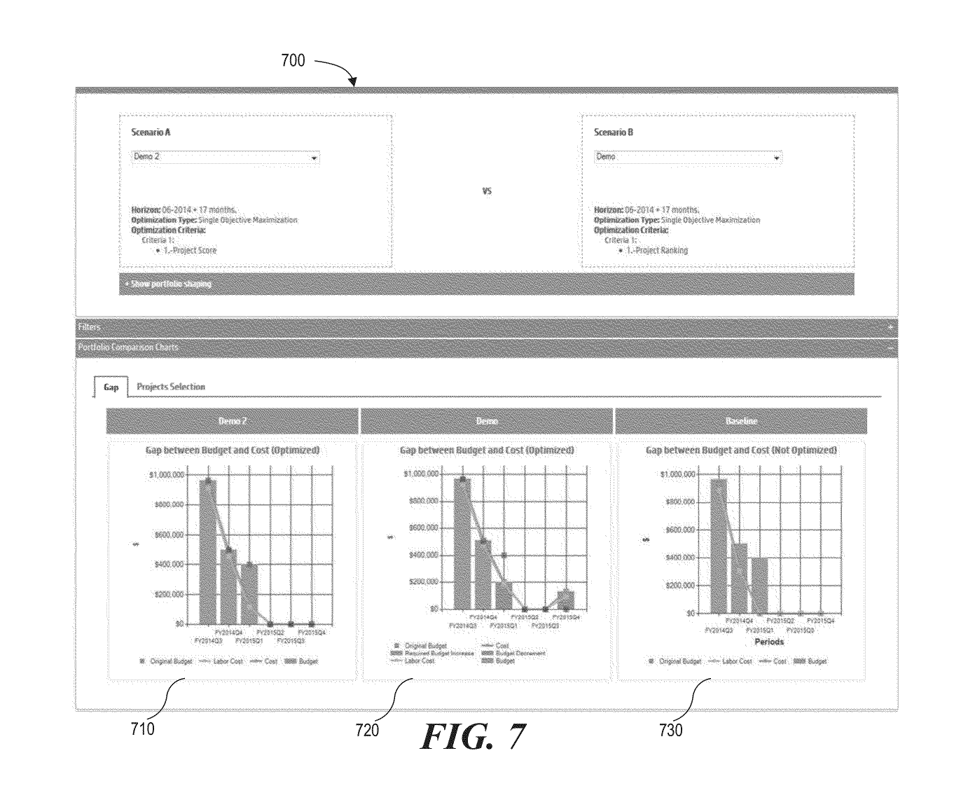

In block 451, a display of graphical representations of the baseline, first, and/or second portfolios may be caused for a side-by-side comparison. An example user interface showing the side-by-side comparison is illustrated in FIG. 7. In the example illustrated in FIG. 7, “Demo2” portfolio optimized based on Scenario A, “Demo” portfolio optimized based on Scenario B, and the baseline portfolio are compared by showing the budget-cost-gap analysis charts for a side-by-side comparison. In this manner, a user may try out several different scenarios, review and compare optimized portfolios generated based on those scenarios, and make an informed decision as to which optimized portfolio to use for the actual implementation. Method 400 may then stop in block 460.

Referring back to FIG. 1, scenario creating engine 121 may be responsible for implementing blocks 431 and 441. Portfolio generating engine 122 may be responsible for implementing blocks 421, 432 and 442. Display triggering engine 125 may be responsible for implementing block 451.

FIG. 5 is a flow diagram depicting an example method 500 for sharing scenarios and optimized portfolios generated based on the scenarios among different users. Method 500 may be implemented in the form of executable instructions stored on a machine-readable storage medium, such as storage medium 210, and/or in the form of electronic circuitry.

Method 500 may start in block 510 and proceed to block 521 where a scenario is created. A scenario may specify at least one objective to be optimized, at least one constraint, and/or at least one configuration parameter. Multiple scenarios may be created to simulate various situations with different objectives, constraints, configuration parameters, and/or other configurations. The objectives, constraints, configuration parameters, and/or other configurations defined in the scenario may be used to generate an optimized portfolio of projects where the projects in the resulting portfolio are selected and scheduled based on this scenario. For example, a mathematical optimization model may determine an optimal selection and scheduling of projects that have been proposed for inclusion in the portfolio while considering the objectives, constraints, configuration parameters, and/or other configurations defined in the scenario. In this way, in block 522, an optimized portfolio may be generated based on the scenario.

In block 523, a first user may make a request to share the scenario with a second user. In response to the request, the second user may be authorized to access the scenario and/or the optimized portfolio if the optimization has been performed on the first scenario. The second user may also gain access to some or all of the graphical representations generated based on the optimized portfolio. The second user may be allowed to modify objectives, constraints, and/or other configuration parameters in the scenario to create a new scenario. In some instances, the second user may comprise a group of users. The group of users may be defined by a geography, role, team, business unit, etc. For example, the first user may share the scenario with his team members. In another example, the first scenario may be shared with all of the employees located in Asia. Method 500 may then stop in block 530.

Referring back to FIG. 1, scenario creating engine 121 may be responsible for implementing block 521. Portfolio generating engine 122 may be responsible for implementing block 522. Scenario sharing engine 126 may be responsible for implementing block 524.

FIG. 6 is a diagram depicting an example user interface 600 for displaying a plurality of graphical representations of an optimized portfolio on a common timeline. User interface 600 (and other user interfaces described herein) may be used to cause various actions to be performed by portfolio optimization system 110.

After a user created a scenario and ran an optimization based on the scenario to generate an optimized portfolio of projects, an output interface such as user interface 600 may be presented to the user to help the user visualize the outcome of the portfolio. In one example, at least two graphical representations of the portfolio may be presented in such a way that they are aligned to a common timeline. The timeline may comprise a graphical illustration of a time axis (e.g., item 610), and time values arranged along the time axis. The time values may illustrate a timescale defined in a unit of time (e.g., hours, days, weeks, months, quarters, years, decades, etc.). In the example illustrated in FIG. 6, a first graphical representation (e.g., item 620) and a second graphical representation (e.g., item 630) may be displayed on a common timeline (e.g., item 610). While the time axis 610 is illustrated in FIG. 6 as a straight line along a horizontal direction, it will be understood that the time axis may have any other suitable shape (e.g., curved, polycurved, non-continuous, etc.), and may have any suitable orientation on a display.

The first graphical representation may be represented as a bar and/or line chart that illustrates how costs and a budget changes while completing the projects over a certain time period. Each bar (e.g., item 621) or vertex (e.g., item 622) of the first graphical representation may indicate the costs (vertex) associated with one or more projects that are scheduled to occur during a portion of the timeline or may indicate the budget (bar) for that portion of the timeline. For example, the bar 621 may indicate information related to the budget for the month of March 2014.

The second graphical representation may comprise a Gantt chart that may illustrate the start and end (or completion) dates of various projects in the portfolio. Each bar (e.g., items 631-636) of the Gantt chart may be associated with a particular project and shows the start and end dates of that project on the timeline (e.g., item 610). Thus, each bar or vertex of the first graphical representation may be aligned with a portion of the bar of the second graphical representation that falls within the same portion of timeline. In the example illustrated in FIG. 6, the portfolio includes six projects (e.g., Projects 100021, 100022, 100023, 100024, 100025, and 100026). Project 100021 has been scheduled to start in March 2014 and end in July 2014. Project 100022 has the same schedule as Project 100021. Project 100023 and Project 100024 start in August 2014 and end in January 2015. Project 100025 starts in January 2015 and ends in June 2015. Project 100026 starts in December 2014 and ends in May 2015. In this example, each bar or vertex of the first graphical representation for the first five months (e.g., March 2014-July 2014) may represent the costs incurred by Projects 100021 and 100022 for each particular month. Similarly, the bar of vertex of the first graphical representation for the month of January 2015 may, for example, indicate the costs incurred by the four projects (e.g., Projects 100023-26) that fall within the same month. Note that the first graphical representation may also illustrate how resources (e.g., budget) are consumed by the projects in the portfolio over time. In some instances, the first graphical representation may illustrate budget-cost gap analysis. By enabling a display of such graphical representations on a common timeline, as discussed above, users may be able to visualize a relationship between the project schedule and the costs (or how resources are consumed).

Moreover, each project may be denoted with an icon to indicate the status of that project. For example, Project 100021 may be shown with an icon 637 to indicate that the project is currently committed and/or is selected by a user and not based on the optimization. On the other hand, Project 100025, in this example, is shown with a different icon 638, which may indicate that the project is selected and scheduled based on the optimization. Different icons may be used to indicate various status of the project.

FIG. 7 is a diagram depicting an example user interface 700 for displaying graphical representations of optimized portfolios for a side-by-side comparison.

User interface 700 may include a display of graphical representations of multiple portfolios for a side-by-side comparison. In the example illustrated in FIG. 7, “Demo2” portfolio optimized based on Scenario A, “Demo” portfolio optimized based on Scenario B, and the baseline portfolio are compared by showing the budget-cost-gap analysis charts 710, 720, and 730 for a side-by-side comparison. In this manner, a user may try out several different scenarios, review and compare optimized portfolios generated based on those scenarios, and make an informed decision as to which optimized portfolio to use for the actual implementation.

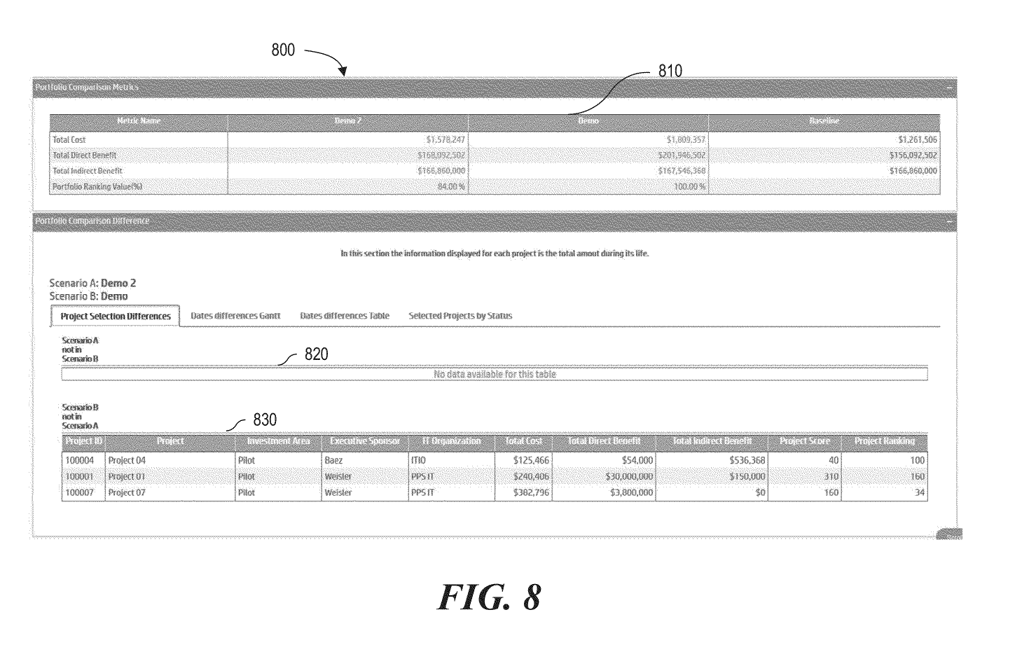

FIG. 8 is a diagram depicting an example user interface 800 for comparing a plurality of optimized portfolios based on differences in project selection.

User interface 800 may include a comparison metrics table 810 that shows comparison of at least two portfolios (e.g., optimized and/or baseline portfolios) based on various metrics. The first column of the table may list different metrics including the total cost, the total direct/indirect benefit, a portfolio ranking value, etc. In the second column of the table, a first optimized portfolio (e.g., “Demo2” portfolios) may be shown with a value corresponding to each metric. The third column may include the values corresponding to the metrics for a second optimized portfolio (e.g., “Demo” portfolio). The fourth column may include the values corresponding to the metrics for a baseline portfolio. Similarly, more columns may be added to the table to show the comparison to additional portfolios.

User interface 800 may include tables 820 and 830 showing project selection differences. For example, a first list of projects that are included in the first portfolio but not in the second portfolio may be shown in table 820. Similarly, table 830 may be generated to show a second list of projects that are included in the second portfolio but not in the first portfolio.

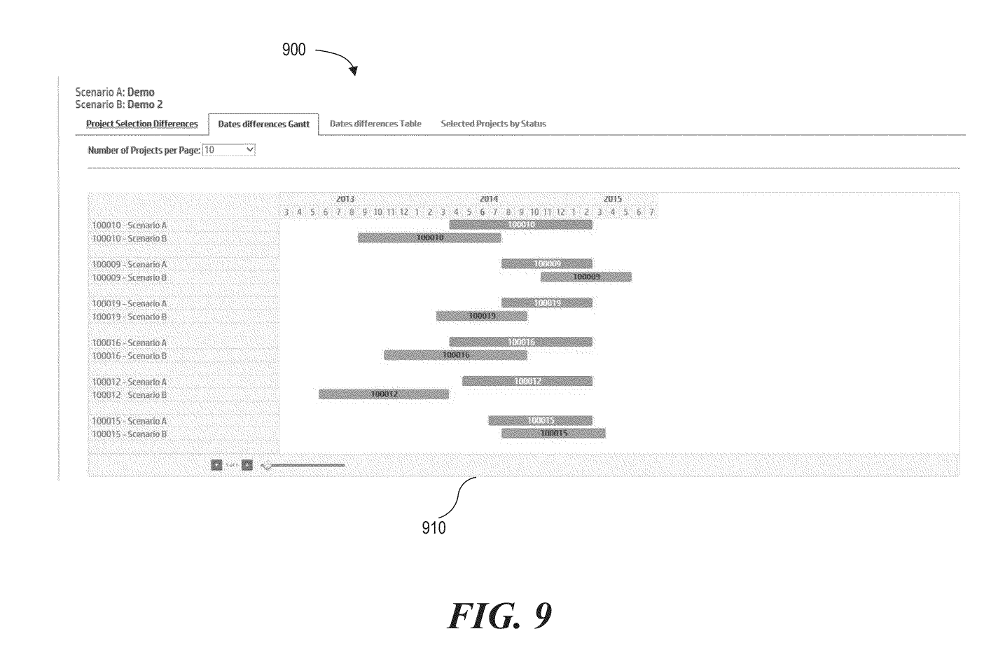

FIG. 9 is a diagram depicting an example user interface 900 for comparing a plurality of optimized portfolios based on differences in project schedule.

User interface 900 may include a Gantt chart 910 that illustrates differences in project schedules. The Gantt chart 910 may show at least one common project that has been selected for both portfolios. For that common project, the Gantt chart may show when that project begins and ends for the first portfolio and when that same project begins and ends for the second portfolio. In the example illustrated in FIG. 9, there are six projects that have been selected for both Scenario A and Scenario B. Those projects include Project 100010, 100009, 100016, 100012, and 100015. Each bar associated with a project indicates the optimized schedule for that project in a particular scenario. For example, Project 100010 is scheduled to start in April 2014 and end in February 2015 for Scenario A whereas the same project is scheduled to start in September 2013 and end in July 2014 for Scenario B.

FIG. 10 is a diagram depicting an example user interface 1000 for managing scenarios for optimizing portfolios of projects.

User interface 1000 may include a list of scenarios 1010 that have been created by a particular user (e.g., User identified as “forozco”). From this list 1010, the user may select a particular scenario and modify various optimization settings (e.g., objectives, constraints, configuration parameters, and/or other configurations) to create a new scenario. The user may select a scenario that has been created but has not been optimized and choose to run the optimization to generate an optimized portfolio based on that scenario. The user may copy or clone an existing scenario shown in the list 1010 to create another scenario. The user may select a particular scenario to share with another user or select a scenario to compare it with a baseline portfolio or at least two scenarios to compare between the scenarios or with the baseline portfolio.

FIG. 11 is a diagram depicting an example user interface 1100 for managing shared scenarios for optimizing portfolios of projects.

Once a scenario is shared with a user by another user or group, that scenario may appear in user interface 1100 through which the user may access or otherwise manage the shared scenario.

The present invention has been shown and described with reference to the foregoing examples. It is to be understood, however, that other forms, details and examples may be made without departing from the spirit and scope of the invention that is defined in the following claims.

1. A method for execution by a computing device for optimizing a portfolio of projects, the method comprising:
triggering a display of a first graphical representation that illustrates costs for executing a first portfolio of projects over a time period, wherein the first portfolio includes a set of projects that is selected and scheduled based on a mathematical optimization model; and
triggering the display of a second graphical representation that illustrates how the set of projects is scheduled over the time period, wherein the first graphical representation and the second graphical representation are aligned to a common timeline.

2. The method of claim 1, wherein the first graphical representation illustrates how resources are consumed by the set of projects over the time period.

3. The method of claim 1, wherein the first graphical representation illustrates budget-cost gap analysis.

4. The method of claim 1, wherein the first graphical representation comprises a bar or line chart, each bar or vertex of the first graphical representation indicating the costs associated with at least one project that is scheduled to occur during a portion of the timeline, wherein the timeline is defined in hours, days, months, quarters, or years.

5. The method of claim 4, wherein the second graphical representation comprises a Gantt chart, and wherein each bar of the Gantt chart is associated with a project and indicates a start date, an end date, and a duration of the project.

6. The method of claim 5, wherein the each bar or vertex of the first graphical representation is aligned with a portion of the each bar of the second graphical representation that falls within the same portion of the timeline.

7. The method of claim 1, further comprising:
creating a first scenario that specifies at least one objective to be optimized and at least one scenario configuration parameter;
generating the first portfolio including the set of projects that is selected and scheduled based on the first scenario;
generating a second portfolio of projects that are selected and scheduled based on a second scenario that is different from the first scenario; and
triggering the display of a graphical representation of the first portfolio and a graphical representation of the second portfolio for a side-by-side comparison.

8. The method of claim 7, further comprising:
triggering the display of a first list of projects that are included in the first portfolio but not in the second portfolio; and
triggering the display of a second list of projects that are included in the second portfolio but not in the first portfolio.

9. The method of claim 7, further comprising:
identifying a project that is common in the first portfolio and the second portfolio, wherein the project has different schedules for the first portfolio and the second portfolio; and
triggering the display of a Gantt chart illustrating the different schedules of the project.

10. The method of claim 7, further comprising:
receiving, from a first user, a request to share the first scenario with a second user; and
authorizing the second user to access the first scenario and the first portfolio.

11. The method of claim 1, further comprising:
triggering the display of a graphical representation of a baseline portfolio for a side-by-side comparison with the graphical representation of the first portfolio, wherein the baseline portfolio includes projects that are currently committed.

12. A machine-readable storage medium comprising instructions executable by a processor of a computing device for optimizing a portfolio of projects, the machine-readable storage medium comprising:
instructions for generating a first time-based chart of costs associated with a first optimized portfolio, wherein the first optimized portfolio is generated by optimizing a selection and scheduling of a set of projects in consideration of at least one objective while satisfying at least one constraint;
instructions for generating a second time-based chart of a project schedule for the first optimized portfolio;
instructions for causing a display of the first time-based chart on a timeline; and
instructions for causing the display of the second time-based chart on the same timeline to enable visualization of a relationship between the project schedule and the costs.

13. The machine-readable storage medium of claim 12, wherein the second time-based chart comprises a Gantt chart, and wherein each bar of the Gantt chart is associated with a project and indicates a start date, an end date, and a duration of the project.

14. The machine-readable storage medium of claim 13, wherein the first time-based chart comprises a bar or line chart, each bar or vertex of the first time-based chart indicating the costs associated with at least one project that is scheduled to occur during a portion of the timeline.

15. The machine-readable storage medium of claim 14, wherein the each bar or vertex of the first time-based chart is aligned with a portion of the each bar of the second time-based chart that falls within the same portion of the timeline.

16. The machine-readable storage medium of claim 13, wherein the first optimized portfolio includes a currently committed project and/or a project that is selected by a user and not based on the optimization, and wherein the machine-readable storage medium further comprises:
instructions for causing the display of a first icon adjacent to or within a first bar of the Gantt chart, wherein the first bar is associated with the currently committed project and/or the project that is selected by the user and not based on the optimization; and
instructions for causing the display of a second icon adjacent to or within a second bar of the Gantt chart, wherein the second bar is associated with a project that is selected and scheduled based on the optimization.

17. A system for optimizing a portfolio of projects comprising:
a processor configured to:
generate a first graphical representation that comprises a time-based chart that illustrates, on a timeline, a distribution of costs involved in executing projects in a project portfolio, wherein the project portfolio is generated based on a what-if scenario that specifies at least one objective to be optimized;
generate a second graphical representation that comprises a Gantt chart that illustrates when each project of the optimized project portfolio begins or ends on the timeline; and
present an output interface for displaying the first and second graphical representations on the same timeline.

18. The system of claim 17, wherein the first graphical representation illustrates, on the timeline, how resources are consumed by the projects in the project portfolio.

19. The system of claim 17, wherein the processor is configured to:
receive, from a first user, a request to share the project portfolio with a second user;
authorize the second user to access the project portfolio; and
present, to the second user, the output interface for displaying the first and second graphical representations.

20. The system of claim 17, wherein the processor is configured to:
receive, from a first user, a request to share the project portfolio with a group of users, wherein the group is defined by a geography, role, team, or a business unit;
authorize the group to access the project portfolio; and
present, to the group, the output interface for displaying the first and second graphical representations.
